(19) United States
(12) Patent Application Publication
(10) Pub. No.: US 2003/0023545 A1
(43) Pub. Date: Jan. 30, 2003

(54) Private label commercial leasing system

(76) Inventors: Joseph W. Hawkins, Birmingham, AL (US); Richard A. Halbrooks, Birmingham, AL (US)

Correspondence Address: DANN DORFMAN HERRELL & SKILLMAN, SUITE 720, 1601 MARKET STREET, PHILADELPHIA, PA, 19103-2307, US

(21) Appl. No.: 10/162,420

(22) Filed: Jun. 4, 2002

Related U.S. Application Data
(60) Provisional application No. 60/295,718, filed on Jun. 4, 2001.

(51) Int. Cl. G06F 17/60

(52) U.S. Cl. 705/38; 705/35

(57) ABSTRACT

A method is provided of marketing and managing a commercial lease program through a bank which does not have such a program. An external commercial leasing company enters into a marketing agreement with the bank wherein marketing materials are provided to bank customers under the bank's brand. Lease applications are made available through the bank to the customers, and are returned to the bank for provision to the external commercial leasing company. The bank may be provided with an option of underwriting the lease or referring the lease for approval to the external commercial leasing company. A commission is paid to the bank for leases underwritten by the external commercial leasing company.

### CROSS REFERENCE TO RELATED APPLICATION

Priority is claimed herein to U.S. Provisional Application No. 60/295,718 filed Jun. 4, 2001, incorporated herein by reference.

### BACKGROUND

Manufacturers and merchants requiring equipment, vehicles, furniture, or other goods for the conduct of their business may purchase such items or they may lease it. In order to purchase expensive equipment, manufacturers and merchants may borrow funds from their preferred bank. However, a significant portion of the equipment used by manufacturers and merchants in the conduct of their business is leased by the manufacturers and merchants, rather than being purchased. It is estimated that 89% of small to medium sized businesses lease some or all of their equipment, and nearly one third of equipment acquired by businesses in 2000 was leased, rather than purchased. The decision to lease or finance the purchase of equipment may be influenced by such factors as conservation of working capital, obsolescence protection, accounting practices, convenience, and tax considerations.

Because commercial leasing is a specialized business, many small banks do not operate a leasing department, and their commercial customers may turn to a business specializing in commercial leasing, or to a larger bank which has a leasing department. In the latter case, the commercial customer may decide to consolidate its banking requirements with a larger bank providing leasing services, to the detriment of their former bank. For a small bank to form its own in-house leasing department would require a commitment of staff, development of documents for establishing and managing leases, losses due to inexperience in the area of commercial leasing, and would require the bank to maintain current awareness of the applicable rules and regulations governing commercial leases. It would therefore be desirable for local banks to have access to a commercial leasing program which would, from the customer's perspective, would operate through the local bank while providing the requisite expertise and resources of an independent commercial leasing company specializing in providing commercial leases.

### SUMMARY OF THE INVENTION

In accordance with the present invention, there is provided a commodity commercial leasing program operated by a commercial leasing company and offered for branding as a service of a bank which does not itself have a commercial leasing program. The commercial leasing company provides educational training to commercial loan personnel of the local bank, markets commercial leases to the bank's customers under the bank's brand, and handles financing and management of the leases. The bank identifies sales prospects to the commercial leasing company, receives a share of revenue derived from the leases, and provides front-line customer support to the leasing customers in accordance with training provided by the commercial leasing company.

### BRIEF DESCRIPTION OF THE DRAWINGS

FIG. I is a functional block diagram showing an embodiment of the invention, and showing the flow of information and services provided thereby among a bank, a commercial leasing company, and customers of the bank; and

FIG. 2 is a logical flow diagram of a leasing process of the invention.

### DETAILED DESCRIPTION OF THE INVENTION

Referring now to FIG. 1, there is shown a bank 10. The bank 10 maintains relationships with commercial customers 12. The commercial customers 12 may be manufacturers, merchants, or other entities who require such items as equipment, furniture, vehicles, and the like in the course of their business. The relationships maintained between the bank 10 and the commercial customers 12 include the maintenance of deposit accounts, financing of loans, and the like. For commercial customers 12 which maintain loans with the bank 10, the bank 10 provides service representatives 14, such as a commercial loan officer. In the preferred embodiment of the invention, the bank 10 does not offer commercial leasing services to its customers.

In order to offer commercial leasing services to its customers 12, the bank 10 enters into an agreement with the commercial leasing company 16. In this first stage of the method, the bank 10 and the commercial leasing company 16 perform the following steps. First, the bank 10 provides data to the commercial leasing company 16 about its commercial loan customers. These customers are the most likely prospects for being interested in obtaining commercial leases. Additionally, the loan department 14 identifies particular commercial loan customers, preferably between about 15 to 25, which are known to the loan department to engage in activities particularly requiring capital equipment in excess of a threshold amount. In the preferred embodiment, this threshold amount is about $ 10,000.

Next, the Bank provides the commercial leasing company with a license to employ the bank's intellectual property, such as trademarks, letterhead, logos, and the like, for production of commercial lease marketing materials incorporating the bank's intellectual property. For example, the commercial leasing company may produce such marketing materials as brochures, letters, and other commercial marketing materials announcing the availability of commercial leases at the bank. The commercial leasing company produces and transmits these marketing materials to the commercial loan customers of the bank. Based on the customer data provided to the commercial leasing company, such materials may further be targeted to address particular areas of commercial activity in which the targeted customers engage.

Concurrent with the provision of customer data and intellectual property to the commercial leasing company, the commercial leasing company provides customer support training and materials to personnel within the bank, preferably loan officers within the loan department of the bank. Such support training includes educating the loan officers about various lease programs available through the commercial leasing company, and about the advantages of leasing in particular economic circumstances. Support materials provided to bank by the commercial leasing company include form documents for applying for a commercial lease and for initiating leases and engaging customers in commercial leases.

The marketing materials produced by the commercial lease company bear the intellectual property of the bank, and direct the customers to contact the bank if they are interested in pursuing a commercial lease. Hence, sending the marketing materials to the customers generates sales leads and inquiries which are directed to the bank, and preferably to the loan department of the bank. In response to requests for lease applications, the bank forwards lease applications directly to the customers. Loan department personnel provide answers to other questions generated by the customers. Inquiries beyond the scope of training of the loan department personnel are referred to the commercial leasing company, which provides specialized customer support services to the customer through the bank and in conjunction with bank personnel. The bank provides ongoing data to the commercial leasing company, such as identifying leads and inquiries generated by the marketing materials, so that the commercial leasing company may gauge the effectiveness of the marketing materials, or further refine the targeting of such materials. In a preferred embodiment, the agreement between the bank and the commercial leasing company provides the commercial leasing company with exclusive access to the customer data and/or an exclusive right to market commercial lease products to the bank's customers. The exclusivity of such a right may be further conditioned on a predefined threshold value of leases offered.

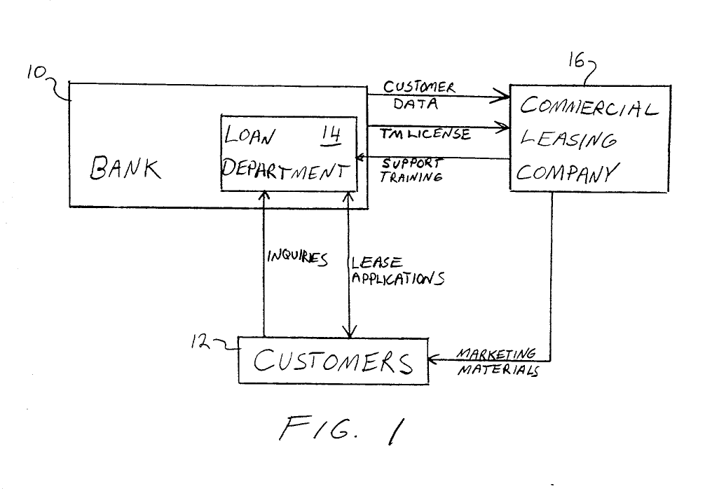

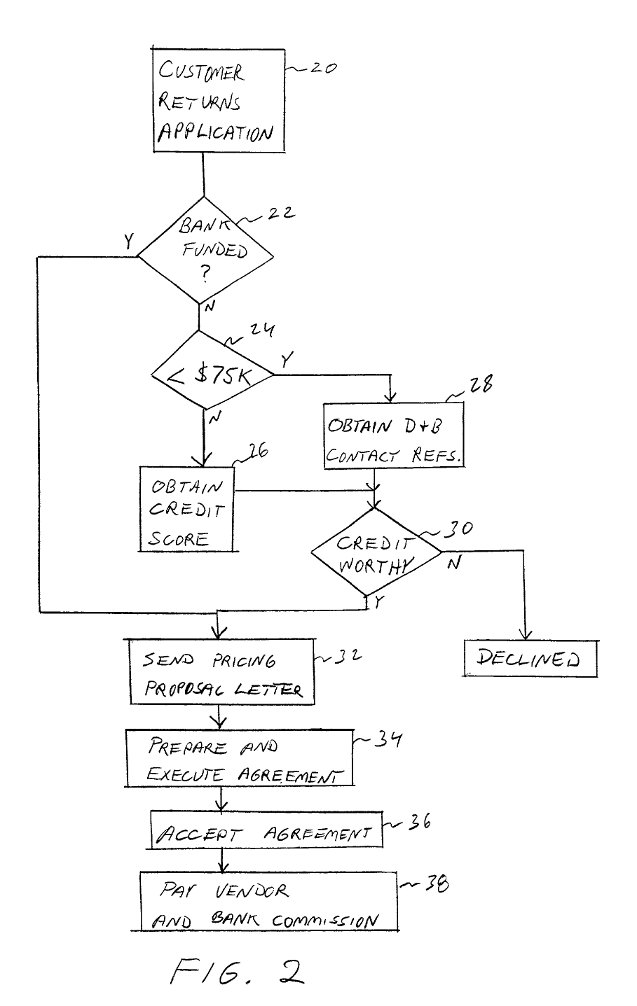

When a customer completes a loan application, the application is processed according to the procedure shown in FIG. 2, showing completion of the application at step 20. In step 22, the bank is given the option of funding the lease, such as by purchasing the equipment to be leased and assuming the credit risk of the lease applicant. If the bank decides to fund the lease, then the method proceeds to step 32. If the bank does not fund the lease, the method proceeds to step 24.

At step 24 it has been determined that the commercial leasing company will finance the lease. The procedure taken by the commercial leasing company to qualify the lease depends on the amount of the lease. In the preferred embodiment, if the lease amount is for less than $75,000, then the commercial lease company proceeds to step 26 to obtain the applicant's credit score. From step 26, the commercial lease company proceeds to step 30.

If, in step 24, the lease amount is greater than $75,000, then the commercial leasing company proceeds to step 28, and undertakes a more detailed review of the credit risk posed by the applicant. Such investigation may include obtaining a Dunn & Bradstreet report on the applicant and/or contacting credit references of the applicant. The commercial leasing company then proceeds to step 30.

At step 30, a determination is made whether the lease is an acceptable risk. If the applicant is determined to be an acceptable risk, then the method proceeds to step 32. Otherwise, the method proceeds to step 33, and the application is declined.

In step 32, a pricing and proposal letter is sent to the applicant, which specifies the terms of a proposed lease, such as the payment, payment interval, cancellation provisions if any, and other terms defining the lease. The pricing and proposal letter is prepared by the commercial leasing company and is sent via the bank loan department. Alternatively, the letter is sent directly to the customer, and identifies the bank as the contact for indicating acceptance of the terms. Then, in step 34, the detailed agreement defining the lease is prepared and sent to the customer for execution, after the customer has indicated that it will accept the terms as proposed in the proposal letter. When the customer has executed the lease agreement, it is returned to the bank. The bank then forwards the lease agreement to the commercial leasing company for final acceptance by the commercial leasing company. The method then proceeds to step 38.

In step 38, the commercial leasing company arranges for payment to the vendor of the equipment to be leased, and pays a commission to the bank as the lease is commenced. In a preferred embodiment, the bank is paid a base commission based on the equipment cost of the lease. For example, the bank may be paid a commission of less than 5%, and preferably about 1.5% of the equipment cost of the lease. For leases which the bank has elected to fund, then the commission is preferably increased, in accordance with the relative increase of risk assumed by the bank. For example, the commission may be doubled in a bank-funded lease transaction relative to a transaction funded by the commercial leasing company. Additionally, the commission structure may depend upon the type of lease, or the type of goods to be leased. For example, commissions on an equipment lease may be greater than those for vehicle leases, such as automobile leases.

In other embodiments, the commercial leasing company and the bank may agree on a threshold limit, such as above $500,000, under which the commission structure will be subject to negotiation between the bank and the commercial leasing company.

That which is claimed is:

1. A method of administering a commercial leasing system through a bank, comprising:
obtaining customer data from the bank;
licensing intellectual property from the bank;
producing lease program marketing materials using the licensed intellectual property;
sending the lease program marketing materials to customers selected from the customer data;
providing lease applications to the bank; and
receiving completed lease applications at the bank.

2. The method of claim 1, wherein the step of obtaining customer data comprises the step of identifying commercial loan customers of the bank.

3. The method of claim 2 wherein the step of obtaining customer data comprises the step of selecting commercial loan customers who have borrowed in excess of a predetermined amount from the bank, and wherein the step of sending the lease program marketing materials to the commercial loan customers selected on such basis.

4. The method of claim 1, wherein the step of obtaining customer data from the bank comprises securing an exclusive agreement with the bank for use of such data for commercial lease marketing purposes.

5. The method of claim 1, further comprising the steps of;
providing the bank with an option to underwrite a commercial lease on the basis of a received application;
determining whether the application qualifies for an outside commercial lease if the bank does not underwrite the lease; and
underwriting the lease external to the bank if the application qualifies.

6. The method of claim 6, comprising the step of paying a commission to the bank for leases underwritten external to the bank.

7. The method of claim 6 wherein the commission value is determined on the basis of a type of lease.

8. The method of claim 1, further comprising the step of providing lease marketing training to bank employees to respond to customer inquiries resulting from receipt of the lease marketing materials.

9. A method of marketing an external commercial lease program through a bank, comprising:
entering into an agreement with the bank to obtain customer data;
sending lease marketing materials to customers selected on the basis of said customer data, and directing said selected customers to respond to the bank;
providing lease application materials to the bank for provision to responding customers;
receiving completed lease application materials at the bank;
underwriting the lease through the external commercial lease program; and
paying a commission to the bank on leases underwritten through the external commercial lease program.

10. The method of claim 9 wherein said agreement is an exclusive agreement to market the commercial lease program.

11. The method of claim 10 wherein said agreeement includes a license of intellectual property from the bank in order to brand the lease marketing materials.

12. The method of claim 10, further comprising the step of providing the bank with the option of underwriting the lease or passing the application to the external commercial lease program.

13. The method of claim 9 wherein the amount of the commission is determined by at least one of a value of the lease, a type of the lease, and the aggregate value of leases generated by the method.
